(19) United States
(12) Patent Application Publication
(10) Pub. No.: US 2009/0307158 A1
(43) Pub. Date: Dec. 10, 2009

(54) METHOD OF DISTRIBUTING ADVERTISING MATERIAL THROUGH RETAIL BUSINESS

(75) Inventors: Mincheol Kim, Tustin, CA (US); Seung Jin Kim, Tustin, CA (US)

Correspondence Address: Mincheol Kim;Crevent, Inc., 246 Robinson Drive, Tustin, CA, 92782, US

(73) Assignee: CREVENT, INC., Tustin, CA (US)

(21) Appl. No.: 12/479,720

(22) Filed: Jun. 5, 2009

Related U.S. Application Data
(60) Provisional application No. 61/059,598, filed on Jun. 6, 2008.

(51) Int. Cl. G06Q 90/00

(52) U.S. Cl. 705/500

(57) ABSTRACT

Disclosed are various methods of advertising one business (advertiser) using another business, which is a retail service or retail sales business, and is not an advertising service business or agent. Some embodiments involve distributing an advertising material of the advertiser to customers of the retail business. The advertising material includes a useful item and advertisement of the advertiser integrated in the useful item. The useful item induces the customers to keep the advertisement for a relatively long period. Some embodiments involve affixing advertisement of the advertiser onto an automobile of a customer of the retail business and providing a value to the customer to induce acceptance of affixing the advertisement.

### RELATED APPLICATION

This application claims the benefit of earlier filing date of U.S. Provisional Patent Application No. 61/059,598, filed Jun. 6, 2008 and titled “Method of Affixing Advertisement onto a Vehicle Surface.” The disclosure of the provisional application is incorporated herein in its entirety by reference.

### BACKGROUND

The present disclosure relates to advertising and more particularly to distributing an advertisement or advertising material of one business through another business. A number of different methods of advertising businesses are available. However, there is always a need for developing and providing a more effective method of advertising.

### SUMMARY

One aspect of the invention provides a method of advertising. The method comprises: selecting a first carwash business among many carwash businesses located in a target geographical area for advertising a professional service business; providing the first carwash business with an advertising material of the professional service business, wherein the advertising material comprises a useful device other than a printed sheet and further comprises advertising information of the professional service business; and causing the first carwash business to distribute the advertising material to customers of the first carwash business.

In the foregoing method, the advertising material may be provided to customers of the first carwash business, who purchase a carwash service from the first carwash business. The method, causing the first carwash business to distribute may comprise causing the first carwash business to install or place the advertising material inside an automobile of a customer who may have purchased a carwash service. The useful device may comprise an automobile accessory.

The foregoing method may comprise: selecting a second carwash business among the many carwash businesses located in the target geographical area; providing the second carwash business with the advertising material of the professional service business; and causing the second carwash business to distribute the advertising material to customers of the second carwash business. The first and second carwash businesses may be caused to distribute the advertising material substantially simultaneously. The first carwash businesses may be caused to start distributing the advertising material first, and then the second carwash business may be caused to start distributing the advertising material after a predetermined period from the first carwash business' starting or completing of distributing the advertising material.

The first carwash business may have a first carwash service premise located in the target geographical area, and the second carwash business may have a second carwash service premise located in the target geographical area, wherein the first and second carwash service premises may be distanced from each other more than a predetermined distance. The first carwash business may have a first carwash service premise located in a first predetermined zone, wherein the second carwash business may be selected as having a second carwash service premise located in a second predetermined zone differing from the first predetermined zone. The first and second predetermined zones may be of two nearby zip codes.

In the foregoing method, the target geographical area may be defined as at least one selected from the group consisting of a city, a county, a metropolitan area, a zip code, a cluster of cities, a cluster of counties, and a cluster of zip codes. No net payment may be made by the professional service business or its agent to the first carwash business for distributing the advertising material. Providing the advertising material may comprise selling the advertising material to the first carwash business at a price about or lower than either or both of the F.O.B. destination cost of the advertising material to the first carwash business and a wholesale price of the useful device in the target geographical area.

In the foregoing method, selecting, providing and causing may be performed by the professional service business or an advertising service. The method may comprise: providing the first carwash business with another advertising material of another professional service business, the other advertising material comprising the useful device or another useful device, the other advertising material may comprise advertising information of the other professional service business; and causing the first carwash business to distribute the other advertising material to customers of the first carwash business. The first carwash business may be caused to distribute the other advertising material of the other professional service business substantially simultaneously with distributing the advertising material or after substantial completion of distributing the advertising material.

Selecting, providing and causing may be performed by the advertising service, wherein the method further may comprise: receiving, by the advertising service, a fee for distributing the advertising material in the target geographical area. The fee may be determined based on at least one selected from the group consisting of an F.O.B. destination cost of the advertising material to the first carwash business, a market price of the useful device in the target geographical area, and a market price of an equivalent device in the target geographical area. The fee may be about or lower than a market price of the useful device or an equivalent device in the target geographical area.

In the foregoing method, the professional service business may be at least one selected from the group consisting of a law firm, a lawyer, an accounting firm, an accountant, a real estate broker, a real estate brokerage firm, a recruiting firm, a recruiting agent, a translator, an engineering firm, a hospital, a clinic, a physician, a business consulting firm, and a business consultant.

Another aspect of the invention provides a method of advertising. The method comprises: making a first arrangement with a professional service business for advertising the professional service business in a target geographical area; selecting a carwash business located in the target geographical area; making a second arrangement with the selected carwash business for distributing an advertising material of the professional service business; providing the carwash business with the advertising material of the professional service business, the advertising material comprising an automobile accessory and may further comprise advertising information of the professional service business; and causing the carwash business to place the advertising material in automobiles of customers, who have purchased a carwash service from the carwash business.

Another aspect of the invention provides a method of advertising. The method comprises: selecting a first retail business having a first business premise in a target geographical area; providing the first retail business with an advertising material of an advertiser other than the first retail business, wherein the advertising material comprises a useful device other than a printed sheet and further comprises advertising information of the advertiser; and causing the first retail business to distribute the advertising material to customers of the first retail business.

In the foregoing method, the advertising material may be provided to customers of the first retail business, who purchase a retail service or product of the first retail business at the first business premise. The first retail business may comprise an automobile related service selected from the group consisting of a carwash service, an oil change service, an automobile repair service, installing an automobile part and removing an automobile part. The method may comprise: selecting a second retail business having a second business premise in the target geographical area; providing the second retail business with the advertising material of the advertiser; and causing the second retail business to distribute the advertising material to customers of the second retail business. The first and second retail businesses may be caused to distribute the advertising material substantially simultaneously. The first retail business may be caused to start distributing the advertising material first, and then the second retail business may be caused to start distributing the advertising material after a predetermined period from the first retail business' starting or completing of distributing the advertising material. The first and second business premises may be distanced from each other more than a predetermined distance.

In the foregoing method, no net payment is made by the advertiser or its gent to the first retail business for distributing the advertising material. The advertising material may comprise an automobile accessory configured to be used inside the automobile. Providing the advertising material may comprise selling the advertising material to the first retail business at a price about or lower than either or both of the F.O.B. destination cost of the advertising material to the first business premise and wholesale prices of the useful device in the target geographical area. Selecting, providing and causing may be performed by the advertiser or an advertising service.

The method may further comprise: providing the first retail business with another advertising material of another advertiser, the other advertising material comprising a useful device other than a printed sheet and may further comprise advertising information of the other advertiser; and causing the first retail business to distribute the other advertising material to customers of the first retail business. The method may further comprise receiving, by the advertising service, a fee for distributing the advertising material in the target geographical area. The fee may be determined based on at least one selected from the group consisting of an F.O.B. destination cost of the advertising material to the first business premise, a market price of the useful device in the target geographical area, and a market price of an equivalent device in the target geographical area. The fee may be about or lower than a market price of the useful device or an equivalent device in the target geographical area.

Another aspect of the invention provides a method of distributing an adverting material of another. The method comprises: running a retail business providing a retail service or a retail sale in a premise; making, by the retail business, an arrangement with an advertiser or its agent for distributing an advertising material of the advertiser; receiving, by the retail business, the advertising material of the second business from the advertiser or its agent, the advertising material comprising the useful device and may further comprise advertising information of the advertiser; providing, by the retail business, the advertising material of the advertiser to customers who make a qualifying purchase from the retail business.

The foregoing method may further comprise: making, by the retail business, an advertisement of the retail business in a town where the premise is located, the advertisement carrying information that the useful device may be provided as a gift for a qualifying purchase from the retail business. The advertisement of the retail business may comprise a coupon or certificate to submit to the retail business for receiving the advertising material of the advertiser along with a qualifying purchase at the premise. The retail service may be an automobile related service selected from the group consisting of an oil change service, a carwash service, an automobile repair service, installing an automobile part and removing an automobile part. Distributing the advertising material may comprise installing the advertising material inside automobiles of the customers.

In the foregoing method, the product may comprise an automobile accessory configured to be installed inside the automobile. The retail business may not receive a compensation or fee from the advertiser or its agent for distributing the advertising material of the second business. The retail business may purchase the advertising material from the advertiser or its agent. The retail business purchases the advertising material at a price that may be determined based on at least one selected from the group consisting of an F.O.B. destination cost for providing the advertising material, wholesale prices of the useful device, and market prices of the useful device.

The foregoing method may further comprise: receiving, by the retail business, another advertising material of another advertiser or its agent, the other advertising material comprising a useful device other than a printed sheet and may further comprise advertising information of the other advertiser; and providing, by the retail business, the other advertising material to customers of the first retail business who make a qualifying purchase from the retail business. The retail business may distribute the other advertising material of the other advertiser to its customers substantially simultaneously with distributing the advertising material of the advertiser or after substantial completion of distributing the advertising material of the advertiser.

Another aspect of the invention provides an advertising material for installing inside an automobile. The advertising material comprises: an automobile accessory installed inside an automobile for normal operation or use; and an advertising module integrated with the automobile accessory and configured to generate advertising information of an advertiser in at least one of visual and audio forms. The advertising material is connected to an electric power supply of the automobile, wherein the advertising module is configured to generate the advertising information upon receiving or detecting electric power from the electric power supply. The advertising information may indicate that the advertising material is provided by the advertiser.

One aspect of the invention is to provide a method of affixing an advertisement of another. The method comprises making, by a business for providing a service or selling a product, an arrangement with an advertiser for affixing an advertisement of the advertiser onto vehicles of others in the context of providing the service or selling the product, wherein the service is other than affixing advertisements onto vehicles. The method further comprises: rendering the service or selling product by the business to a customer; upon permission of the customer, affixing, by the business, the advertisement onto the customer's automobile in accordance with the arrangement; providing, by the business, the customer with a value in return for affixing the advertisement in accordance with the arrangement; and receiving, by the business, a consideration from the advertiser for affixing the advertisement and providing the value in accordance with the arrangement.

In the foregoing method of affixing advertisement of another, the value may be selected from the group consisting of a discount for the service rendered; removal of at least part of an amount charged for the service rendered; an additional service at a discounted rate; an additional service for free; cash; a gift certificate for use in the business, the advertiser or a third party business; points or mileage for a frequent customer reward program of the business, the advertiser or the third party business; a discount coupon for use in the business, the advertiser or a third party business; a voucher for use in the business, the advertiser or a third party business; and a combination of two or more of the foregoing. The consideration may vary based on at least one selected from the size of the advertisement, the location of affixing, and a content appearing on the advertisement.

The foregoing method of affixing advertisement of another method may further comprise: reporting, to the advertiser, affixing of the advertisement onto the customer's vehicle, and wherein receiving the consideration may be subsequent to reporting. The advertiser may be at least one selected from the group consisting of an attorney specializing in criminal defense, an attorney specializing in personal injury, an attorney specializing in DUI, a vehicle accident assistance service, a vehicle roadside assistance service, a vehicle towing service, a vehicle repair service, and a vehicle emergency assistance service. The affixing of the advertisement may comprise permanently or substantially permanently attaching or creating the advertisement onto a surface of the vehicle, wherein substantially permanently attaching or creating means that cleanly removing the advertisement requires a chemical treatment that uses a chemical and/or a mechanical treatment using a mechanical tool. The value may be at least partly subsidized by the advertiser.

Another aspect of the invention provides a method of affixing an advertisement of another onto a customer's vehicle. The method comprises: inquiring, by a business, a customer if the customer would agree to affixing an advertisement of an advertiser onto a vehicle that the customer has driven in and further agree to receiving a consideration in return for affixing the advertisement; upon the customer's agreement, affixing, by the business, the advertisement onto the customer's vehicle; and providing, by the business, the customer with the agreed upon consideration. The method may further comprise performing, by the business, to render a service and/or selling a product to the customer.

The foregoing method of affixing onto a customer's vehicle may further comprise receiving, from the advertiser, a fee for affixing of the advertisement onto the customer's vehicle. The method may further comprise reporting, to the advertiser, affixing of the advertisement onto the customer's vehicle, and wherein receiving the fee may be subsequent to reporting. The reporting may comprise sending an evidence of affixing of the advertisement onto the customer's vehicle. The evidence may comprise a copy of a registration card of the customer's vehicle.

Another aspect of the invention provides a method of running a vehicle incidence assistance service. The method comprising: providing a possessor of a vehicle with a consideration in return for permitting to affix an advertisement onto the vehicle, wherein the advertisement comprises a telephone number; subsequently, receiving a telephone call from a driver or passenger of the vehicle at the telephone number for consultation regarding an incidence involving the vehicle or driver of the vehicle; and rendering an advice as to how to handle the incidence to the driver or passenger over the phone.

In the method of running a vehicle incidence assistance service, the vehicle incidence may comprise at least one selected from the group consisting of a traffic accident, a stop by a law enforcement officer for a potential traffic violation, a stop by a law enforcement officer for a testing for driving under intoxication, and an emergency situation that occurs during driving. The advice may comprise a legal advice. The advice may comprise at least one action selected from the group consisting of making or keeping a record of the incidence, reporting the incident to a law enforcement agency, reporting the incident to an insurance company, cleaning a site of the incidence, and treating a person involving the incidence.

The method of running a vehicle incidence assistance service may further comprise: referring the driver or passenger to a third party service that can be of further assistance to the driver or passenger regarding the incidence. The method may further comprise conducting a search using a database comprising a plurality of service entries, thereby locating the third party service. Here, the third party service may be at least one selected from the group consisting of an attorney specializing in criminal defense, an attorney specializing in personal injury, an attorney specializing in DUI, a vehicle accident assistance service, a vehicle roadside assistance service, a vehicle towing service, a vehicle repair service, and a vehicle emergency assistance service. The method may further comprise receiving a subscription fee from each service of the plurality of service entries for being included in the database.

In the foregoing method where a referral is made to a third party service, the method may further comprise receiving a referral fee from the third party service for connecting the driver or passenger thereto. The referral fee may be predetermined. The referral fee may be calculated as a function of a service fee that may be charged by the third party service to the driver, passenger or another who has hired the third party service. The referral may comprise putting the telephone call through to the third party service. The referral may comprise providing contact information of the driver or passenger to the third party service such that the third party service can contact the driver or passenger. The referral may comprise providing the driver or passenger with contact information of the third party service such that the driver, passenger or another person can contact the third party service. The method may further comprise providing the driver or passenger with a referral number with information that the third party service may be to provide a service at a discounted rate.

Another aspect of the invention provides a method of affixing an advertisement onto a vehicle of a registrant. The method comprises: offering, by an advertiser, a value in return for registering and affixing an advertisement onto a vehicle; receiving, by the advertiser, a registration request from a vehicle possessor, wherein the request comprises vehicle identification information and a mailing address of the possessor; mailing, by the advertiser, to the mailing address a registration confirmation along with an instruction as to how to receive the value; checking, by the advertiser, to see if the advertisement has been properly affixed onto the vehicle; and providing, by the advertiser, the value to the possessor.

In the foregoing method of affixing an advertisement onto a vehicle of a registrant, the advertisement may be in the form of a sticker. The advertisement sticker may comprise the registration confirmation. The instruction may instruct the possessor to affix the advertisement onto the vehicle and further provides information where to receive the value. The instruction may instruct the possessor to take the advertisement to a predetermined location where the advertisement may be to be affixed by an agent of the advertiser onto the vehicle the value may be to be provided. The request may be received by mail, facsimile transmission, phone or an electronic transmission via the Internet.

The advertisement sticker may be further mailed along with the registration confirmation. The advertisement sticker may be configured so as to be substantially permanently affixed onto the vehicle. Once affixed, the advertisement sticker may be configured so as not to be removed without damaging a surface of the vehicle or without leaving an artifact on the surface that require a chemical and/or mechanical treatment for removing. At least one of checking and/or providing may be performed by the advertiser or a third party business on behalf of the advertiser. The third party business renders a service or sells a product to the possessor, in which the value may comprise a reduction of a price for the service or product.

### BRIEF DESCRIPTION OF DRAWINGS

FIG. 1 illustrates one embodiment of distributing an advertising material of a personal injury lawyer via a carwash business.

FIG. 2 illustrates distribution of an advertising material via a retail business according to one embodiment.

FIG. 3 illustrates distribution of an advertising material via a retail business according to one embodiment.

FIG. 4 illustrates distribution of an advertising material via a retail business according to one embodiment.

FIG. 5 is a flowchart for distributing an advertising material, applicable to the embodiments of FIGS. 2-4

FIG. 6 illustrates changing of useful items over time according to one embodiment.

FIG. 7 illustrates changing of useful items over time according to another embodiment.

FIG. 8 is a flowchart for affixing an advertisement of an advertiser onto an interior surface of an automobile of a customer of a retail business according to one embodiment.

FIG. 9 is a flowchart for providing a coupon to a person who registered for receiving value in return for permitting affixing of an advertisement inside his/her automobile according to embodiment.

### DETAILED DESCRIPTION OF EMBODIMENTS

Various features of the invention will become more fully apparent from the following description and appended claims taken in conjunction with the foregoing drawings. In the drawings, like reference numerals indicate identical or functionally similar elements.

Various embodiments in the disclosure are directed to advertising one business (advertiser) using another business, which is a retail service or retail sales business, and is not an advertising service business or agent. Some embodiments involve distributing an advertising material of the advertiser to customers of the retail business. In some embodiments, the advertising material includes a useful item and advertisement of the advertiser integrated in the useful item so as to induce the customer to keep the advertisement for a relatively long period of time. Some embodiments involve providing a value to the customers to induce acceptance of the advertising material. Some embodiments involve affixing advertisement onto automobiles of the customers.

### Distributing Advertising Material Via Carwash Business

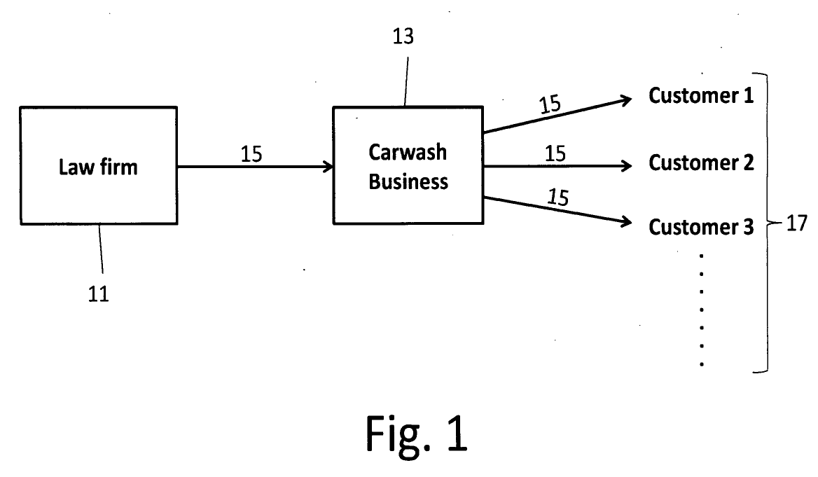

In one embodiment illustrated in FIG. 1, a professional service business uses a carwash business as a channel for advertising its business. In the embodiment, the professional service is preferably a lawyer or law firm 11, and more preferably a lawyer (or law firm, hereinafter “lawyer”) specializing in personal injury law practice. The carwash business 13 distributes the advertising material 15 of the lawyer 11 to customers 17 of the carwash business 13. In this embodiment, the advertising material 15 includes an automobile accessory for use inside an automobile and further includes information or a content that advertises the lawyer 11. The lawyer 11 provides the carwash business 13 with the advertising material 15 for free or at a price significantly lower than a market price of the automobile accessory. In this embodiment, the carwash business 13 distributes the advertising material 15 to its customers 17, who purchase its carwash business. The carwash business 13 provides the advertising material 15 to its customers for free or at a price significantly lower than its market price.

The combination of a personal injury lawyer or law firm as advertiser, an automobile accessory an advertising material, and a carwash business as distributor provides unique benefits that have not been explored before. First, because customers of the carwash business are primarily drivers of an automobile, the personal injury lawyer or law firm can distribute its advertising material to automobile drivers. Generally automobile drivers are desired audience for personal injury lawyer or law firm's advertising given that a significant portion of the personal injury lawyer or law firm's clients comes from automobile accidents. Thus, the personal injury lawyer or law firm can advertise its practice to a desired target audience.

Typically, carwash businesses have their customers in the local communities where they are located, and therefore the advertising materials are primarily distributed to drivers who are living or working in the area where the carwash business. Thus, by selecting a carwash business in a desired geographical area, the personal injury lawyer or law firm can advertise its practice in the desired geographical area or its neighboring areas.

Generally, an automobile accessory, once installed, is used inside an automobile for an extended period of time. Thus, the personal injury lawyer or law firm can have the benefit of advertising for an extended period time. Further, when installed at an appropriate location inside an automobile, the advertising information or content of the personal injury lawyer or law firm would be exposed frequently, such as almost every time the driver drives the automatically. Given the extended and frequent exposure to the advertising information, which is not competing with advertising information or content of other personal injury lawyers or law firms, the driver may want to contact the personal injury lawyer or law firm when needed or may provide the advertising information or content to someone who is in need of such information.

Furthermore, customers of the carwash business would prefer to use the carwash business over other carwash businesses. As the carwash business continues to distribute automobile accessories, the customers would build an expectation that they would obtain from the carwash business an automobile accessory for free or at a price much less expensive than its market price.

In another embodiment, the advertising material includes advertising information or content of the carwash business in addition to the advertising information or content of the lawyer. Thus, automobile accessories used for advertising material works for both the lawyer and the carwash business.

### Variations

Now variations of the foregoing embodiment will be discussed. In these embodiments, the professional service or lawyer 11 is generalized as an advertiser, and the carwash business 13 is generalized as a retail business.

### Channels of Distributing Advertising Materials

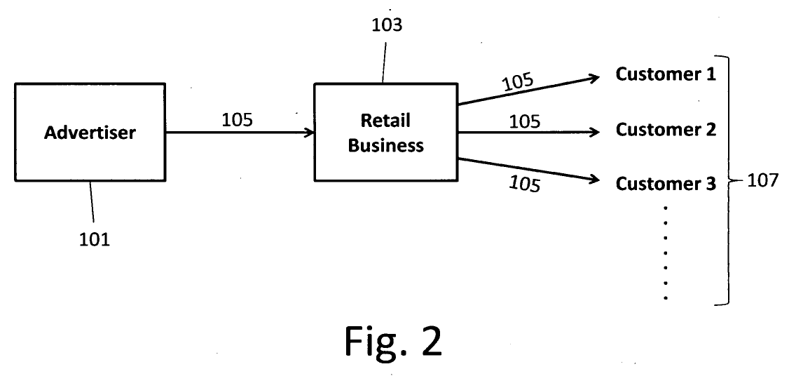

In one embodiment of advertising, an advertising material of one business or advertiser is distributed to potential customers of the business using a retail business, which is different from the advertiser's business being promoted. Referring to FIG. 2, an advertiser 101 uses a retail business 103 as a channel for distributing its advertising material 105. More specifically, the advertiser 101 provides the retail business 103 with the advertising material 105. Then, the retail business 103 distributes the advertising material 105 to customers 107 of the retail business 103, in the context of the retail business.

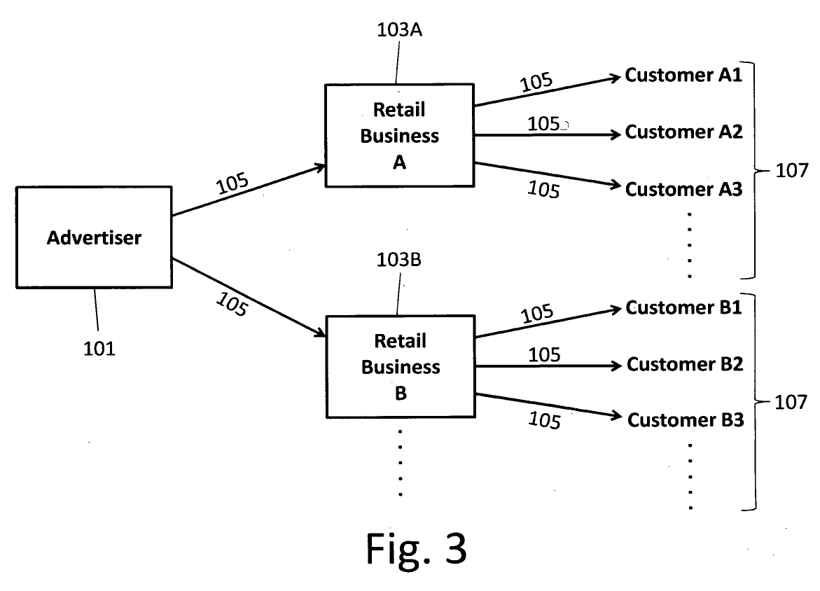

In one embodiment illustrated in FIG. 3, the advertiser 101 uses two or more retail businesses 103A, 103B for distributing the advertising material 105 of the advertiser 101. In this embodiment, each retail business 103A, 103B distributes the advertising material 105 to their individual customers 107A, 107B, respectively. In one embodiment, the retail business 103A distributes the advertising material 105 for a first period, and the retail business 103B distributes the advertising material 105 for a second period. Here, the first period and second period may or may not overlap. In one embodiment, the advertising materials distributed via the retail businesses 103A and 103B differ from each other.

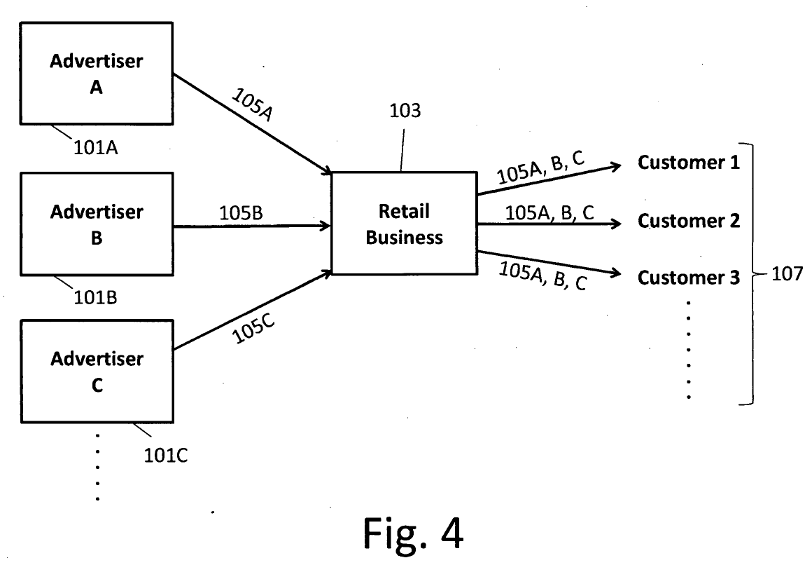

In one embodiment illustrated in FIG. 4, a single retail business may distribute advertising materials of more than one advertiser. Referring to FIG. 4, advertisers 101A, 101B, 101C provide their own advertising materials 105A, 105B, 105C to a single retail business 103, who then distributes the advertising materials 105A, 105B, 105C to its customers 107. In this embodiment, individual advertisers 101A, 101B, 101C may also distribute their advertising materials 105A, 105B, 105C through other retail business (not illustrated).

### Advertiser

Any businesses can be the advertiser 101 of the embodiments of FIGS. 2-4 and their variations. However, the advertiser 101 itself is not an advertising service or agent who serves other businesses for advertising or promoting the other businesses. Further, the advertiser 101 itself is not the retail business 103 or an arm or operation of the retail business 103. In one embodiment, the advertiser 101 is a retail sales business, a retail service business, a whole sale business or a manufacturer. In one embodiment, the advertiser 101 is a professional service business or a consortium of professional service businesses. Here, the professional service business includes, but not limited to, a law firm, a lawyer, an accounting firm, an accountant, a real estate broker, a real estate brokerage firm, a recruiting firm, a recruiting agent, a translator, an engineering firm, a hospital, a clinic, a physician, a business consulting firm, and a business consultant.

### Retail Business

In embodiments, the retail business 101 is a business providing a retail service or retail sales to customers at a business premise. Preferably, the retail business 101 is a type of business, in which many customers need to visit the business premise. In one embodiment, the retail business 103 provides services relating to automobiles or sells goods relating to automobiles. For example, the retail business 103 is a carwash service, an oil change service, an automobile repair service, a gas station business, a retail store for automobile parts, a retail store for automobile accessories a grocery market, a department store, a retail store business or a restaurant.

### Advertising Material

In embodiments, the advertising material 105 includes a useful item or device and further includes advertising information or content of the advertiser 101. In some embodiments, the advertising material 105 may include advertising information or content of the retail business 103 in addition to the advertising content of the advertiser 101. In embodiments, the advertising information or content of the advertiser includes one or more of the business name, contact information, and goods or services of the advertiser 101. The advertising information is unique to and identifies the particular advertiser 101. The advertising information or content of the retail business includes one or more of the business name, contact information, and goods or services of the retail business 103.

The advertising information or content of the advertiser 101 is unique to and identifies the particular advertiser 101. In other words, each of the advertising material 105A, 105B, 105C has different advertising information for the advertisers 101A, 101B, 101C, respectively. Accordingly, the advertising material 105 is identified by the advertising information or content. The same applies to the advertising content of the retail business 103.

The useful item or device is something that has an inherent value other than its advertising value. The useful item or device does not refer to a flyer or business card that carries advertising information of the advertiser 101 or the retail business 103. In one embodiment, the useful item or device includes an automobile accessory that is to be installed and used inside an automobile. For example, the useful item or device includes, but not limited to, an air freshener, an air purifier, a radar detector, a rearview mirror, a non-slip pad to place on a dashboard, an automobile power adaptor, a CD organizer, an automobile organizer, an emergency kit, a first aid kit, a cup holder, etc. Using an automobile accessory for use inside an automobile as the advertising material 105 provides a lot of advantages in advertising the advertiser's business, goods or services. The American life style depends very much on use of automobiles. Thus, the advertising material 105 and its advertising information installed inside an automobile would be repeatedly or constantly exposed to driver of the automobile and guests.

In other embodiments, the useful item or device includes something that can be used or carried by people. For example, the useful item or device includes, but not limited to, an umbrella, a memory chip, a pen, a CD containing a multimedia content, a DVD containing a multimedia content, a cap, a hat, a keychain, a towel, a watch, a note pad, a sticky (post-it) note, etc.

In some embodiment, the advertising information is in the form of a digitally reproducible content stored in the useful item, when it can be used in a computing device or a digital playback device. In one embodiment, the advertising information is configured to be played when using the useful item in a computing device or a digital playback device.

In other embodiments, the advertising information or content is placed, printed or embedded on one or more surfaces of the useful item. In one embodiment, the advertising material 105 includes advertising contents of both advertiser 101 and retail business 103 on a single continuous surface of the useful item or device. In another embodiment, the advertising material 105 includes an advertising content of the advertiser 101 on a surface of the useful item or device and an advertising content of the retail business 103 on another surface of the useful item, which is separate or discontinuous from the surface including the advertising content of the advertiser 101.

In some embodiments, the advertising material 105 includes a digital display configured to display advertising information of the advertiser 101. In some embodiments, the advertising material 105 includes an audio playback module configured to play an audio recording of advertising information of the advertiser 101. For example, the digital display and/or audio playback module is configured to display or play advertising information indicating the useful item of device is provided or sponsored by the advertiser 101. In some embodiments where the advertising material 105 is an automobile accessory, it is connected to an electric power system of the automobile and is initiated to play the advertising information at the time or some time after the automobile is turned on. In one of such embodiments, the advertising material 105 is activated and turned on when the automobile is turned on. In another of such embodiments, the advertising material 105 is configured to detect activation of the automobile electric power system, and further configured to display and/or play the advertising information.

### Procedure

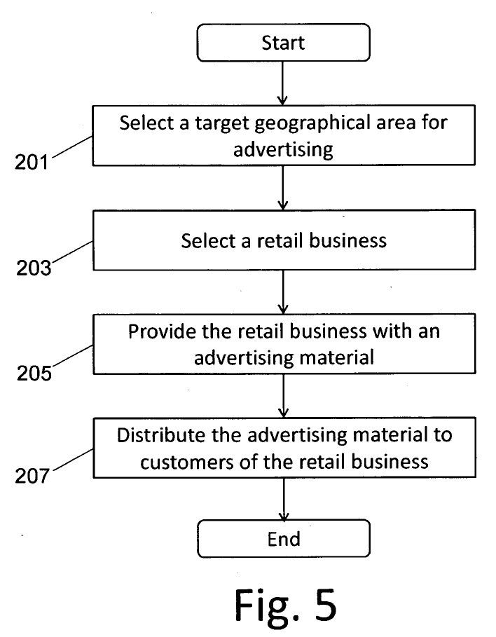

Now referring to the flowchart of FIG. 5, a procedure for distributing advertising materials is discussed. The procedure can be implemented in the embodiments illustrated in FIGS. 1-3 and their variations. At first, the advertiser 101 selects a target geographical area for advertising (step 201). Then the advertiser 101 selects a retail business 103 for distributing its advertising material 105 (step 203). The advertiser 101 provides the retail business 103 with its advertising material 105 (step 205). Then the retail business 103 distributes the advertising material 105 of the advertiser 101 to its customers 107 in the context of its retail business operation (step 207).

### Selecting Target Geographical Area

At step 201, the advertiser 101 selects a target geographical area, in which to advertise its goods and services. In embodiments, the target geographical area is selected from areas where the advertiser 101 has a business office or facility, where current and potential customers or clients reside or have offices, where the advertiser 101 desires to expand its business to, etc. In embodiments, the target geographical area is defined as a town, a city, a county, a metropolitan area, a zip code, a cluster of cities, a cluster of counties or a cluster of zip codes. In some embodiments, electing a target geographical area occurs almost simultaneously with the step of selecting the retail business 103.

### Selecting Retail Business in Target Geographical Area

At step 203, the advertiser 101 selects the retail business 103 for distributing the advertising material 105 in the target geographical area. In one embodiment, the advertiser 101 selects at least one type of retail business among many different types of retail businesses available in the target geographical area. Then, the advertiser 101 identifies many retail businesses operating in the target geographical area that are of the selected type. Further, the advertiser 101 selects at least one particular retail business among those many retail businesses that are of the selected type. In another embodiment, the advertiser 101 considers many retail businesses available in the target geographical area and select one particular retail business 103 for the distribution of advertising material 105.

In some embodiments, two or more retail businesses 103A, 103B, 103C distribute advertising material 105 of the advertiser 101 at the same time or during overlapping periods. Also, in other embodiments, two or more retail businesses 103A, 103B, 103C respectively distribute advertising materials 105A, 105B, 105C of the advertisers 101A, 101B, 101C at the same time or overlapping periods. In these embodiments where two or more retail businesses simultaneously distribute advertising materials, the two or more retail businesses are selected such that distributions by these two or more retail businesses compete with each other. In one embodiment, two or more retail businesses are selected such that they are distanced from one another by at least a predetermined distance while located in the same geographical area. In another embodiment, the target geographical area is divided into a plurality of predetermined zones, which may be local administrative districts such as zip codes, cities, etc., and the two or more retail businesses are located in different predetermined zones.

### Providing Advertising Material to Retail Business

At step 205, the advertiser 101 provides the selected retail business 103 with an advertising material 105. To perform this step, the advertiser 101 forms an arrangement with the retail business 105 for the distribution of advertising material 105. In embodiments, the arrangement may specify terms and conditions relating to supplying of the advertising material 105 to the retail business 103. Further in embodiments, the arrangements may specify terms and conditions relating to distribution of the advertising material 105 to customers 107 of the retail business 103.

In one embodiment, the advertiser 101 does not pay the retail business 103 for the service of distributing the advertising material 105 for the advertiser 101. In another embodiment, the advertiser 101 sells the advertising material 105 to the retail business 103 and pays to the retail business 103 for the distribution service; however, overall there is no net payment that the advertiser 101 makes to the retail business 103.

In one embodiment, the advertising material 105 is provided to the retail business 103 free of charge even if the advertising material's useful item has a value in the marketplace. The advertising material 105 is provided free to motivate the retail business 103 to participate in distribution of the advertising material of the advertiser 101.

In other embodiments, the advertising material 105 is sold to the retail business 103 at a price lower than an average retail price of the useful item or device in the target geographical market, whether it is available at a retail store or at an on-line store accessible in the target geographical area. In one embodiment, the price is about or lower than an F.O.B. destination cost of the advertising material 101 to the retail business. In another embodiment, the price of about or lower than a wholesale price of the useful device in the target geographical area. The advertising material 105 is sold at a price to avoid or prevent the retail business 103 from abusing or wasting the advertising material 105; and the price is lower than the market retail price to motivate the participation of the retail business 103.

In some embodiments, the advertising material 105 is prepared after the arrangement with the retail business 103. This is particularly so when the advertising material 105 includes an advertising content of the retail business 103 as well as the advertising content of the advertiser 101. In such embodiments where the advertising material 105 includes advertising content of the retail business 103, the advertising material 105 may be sold to the retail business 103. In these embodiments, the advertising material 105 may still be sold at a price lower than an average retail price of the useful item or device in the target geographical market, whether it is available at a retail store or at an on-line store accessible in the target geographical area.

### Distributing Advertising Materials to Customers of Retail Business

At step 207, the retail business 103 distributes the advertising material 103 to its customers 107 in the context of its retail business operation. In some embodiments, the retail business 103 provides the advertising material 103 to its customers 107 for free. In other embodiments, the retail business 103 sells the advertising materials 103 to its customers at a price substantially lower than an average retail price of the useful item or device available in the target geographical area, whether the useful item or device is available at a retail store or at an on-line store accessible in the target geographical area. The price substantially lower than the average market retail price refers to a price lower than 10%, 20%, 30%, 40%, 50%, 60% or 70% of the average market retail price.

In these embodiments, the retail business 103 provides the advertising material 105 for free or at a price substantially lower than a market price to reward its customers for their purchases and to draw attention of potential customers to its retail business in the target geographical area. In these embodiments, the retail business 103 may build a good will in its customers 107 with an expectation that the customers 107 would receive a value that is not offered or provided by its competitors.

In some embodiments, the retail business 103 provides the advertising material 105 of the advertiser 101 only to its customers who have purchased a product or service from the retail business 103. In one embodiment, the retail business 103 provides the advertising material 105 to its customers who have submitted a coupon or certificate to the retail business 103 with or without purchase of its product or service. In this embodiment, the coupon or certificate is one that the retail business 103 (alone or together with the advertiser 101) has circulated in the target geographical area and indicates that a gift item (here the advertising material 105) is provided when submitting the coupon or certificate.

In one embodiment where the retail business 103 relates to automobiles of the customers 107 such as a carwash service business, the retail business 103 places or installs the advertising material 105 inside the customers' automobiles before delivery of the automobile. In some embodiments, the advertising material 105 is handed over to the customers 107 at the time of payment for the retail purchase by the customer 107 to the retail business 103. In other embodiments, the delivery of the advertising material 105 occurs at anytime while the customer 107 is at the business premise of the retail business 103.

In some embodiments, the retail business 103 distributes more than one advertising material 105 at the same time, and these more than one advertising material are of more than one useful item or device. Here, more than one useful item or device includes the same item having slightly different features. For example, the advertising material 105 includes the useful item of air fresheners having different flavors or scents. In these embodiments where the retail business 103 distributes more than one advertising material 105 with more than one useful item, the retail business 103 may first ask to its customer 107 which one of useful items would like to ask, and provide the advertising material 105 using the useful item selected by the customer 107. For example, the retail business 103 may ask about what scent of air freshener the customer 107 prefers, and provide an advertising material 105 using the air freshener of the scent the customer 107 prefers.

### Coordination by Advertising Service or Agent

In the foregoing embodiments and their variations, the advertiser 101 may use an advertising service or agent, which is a business independent of the advertiser 101, for distributing its advertising material 105. In one embodiment, the advertiser 101 may form an arrangement with the advertising service or agent to perform all or some of the acts of the foregoing embodiments for distributing the advertising material 105. The advertising service or agent may assist the advertiser 101 for identifying and selecting the target geographical area and/or the retail business 103. Also, the advertising service or agent may assist the advertiser 101 to form an arrangement with the retail business 103 and/or to provide the advertising material 105 to the retail business 103. Throughout this disclosure, any acts of the advertiser 101 can be conducted or performed by an advertising service or agent of the advertiser 101 in replacement with or in addition to acts of the advertiser 101, unless stated otherwise.

In the embodiments where the advertising service or agent is involved, the advertiser 101 may pay a fee for its services relating to the distribution of the advertising material 105 of the advertiser 101. In some embodiments, the fee for the advertising service or agent includes one component that is determined based on either or both of an F.O.B. destination cost of the advertising material to the retail business and an average market price of the useful device in the target geographical area, whether the useful item or device is available at a retail store or at an on-line store. In some embodiment, the total fee is about or lower than an F.O.B. destination cost of the advertising material to the retail business and an average market price of the useful device in the target geographical area, whether the useful item or device is available at a retail store or at an on-line store.

### Pre-Selecting Retail Business

In some embodiments where an advertising service or agent is involved, the advertising service or agent may have already pre-selected one or more retail businesses. In such embodiments, determining to use one of the pre-selected retail businesses constitutes the step of selecting a retail business. The advertising service or agent may suggest to the advertiser 101 one of the pre-selected retail businesses is suitable to distribute the advertising material 105 of the advertiser 101.

### Changing Advertising Material

In embodiments, the advertising material 105 distributed may be changed over time occasionally, periodically, sporadically, or according to a plan. In the embodiment of FIG. 4 and its variations, a change from one advertiser 101A to another advertiser 101B for the same retail business 103 necessarily results in a change from one advertising material 105A to another advertising material 105B, given that the advertising information of the advertising materials 105A, 105B identifies the advertiser 101A, 101B, respectively. In some embodiments, the advertisers 101A, 101B may the same useful item or device for their respective advertising materials 105A, 105B. In other embodiments, the advertisers 101A, 101B may use different useful items in their respective advertising materials 105A, 105B.

Additionally, in the embodiments of FIGS. 2-4 and their variations, the advertising material 105 (or 105A) of the same advertiser 101 (or 101A) may change over time. In one embodiment, the advertiser 101 (or 101A) may provide one advertising material for a period and then change it to another advertising material. In this embodiment, the advertiser 101 (or 101A) may change either or both of the useful item or device and the advertising information.

Changing the useful items distributed by a single retail business 103 over time provides the benefit that the retail business 103 may continuously or continually attracts or draws the attention of its customers 107. When the useful item used in the advertising material 105 can be used for a long period time, customers 107 who have received the useful item may not be interested in receiving the same item. Therefore, changing of the useful item over time can attract continuous attention and interest of the customers 107. In case the useful item is something to use for a relatively short period of time, such as air refresher, distributing the same item for a long period time may have possibly negative impact in the advertising of the advertiser 101 as the repeating customers may discard the useful item when they receive a new one from the retail business. Changing of the useful item over time can avoid this consequence.

### Advertising Service's Coordinating Changes of Advertising Materials

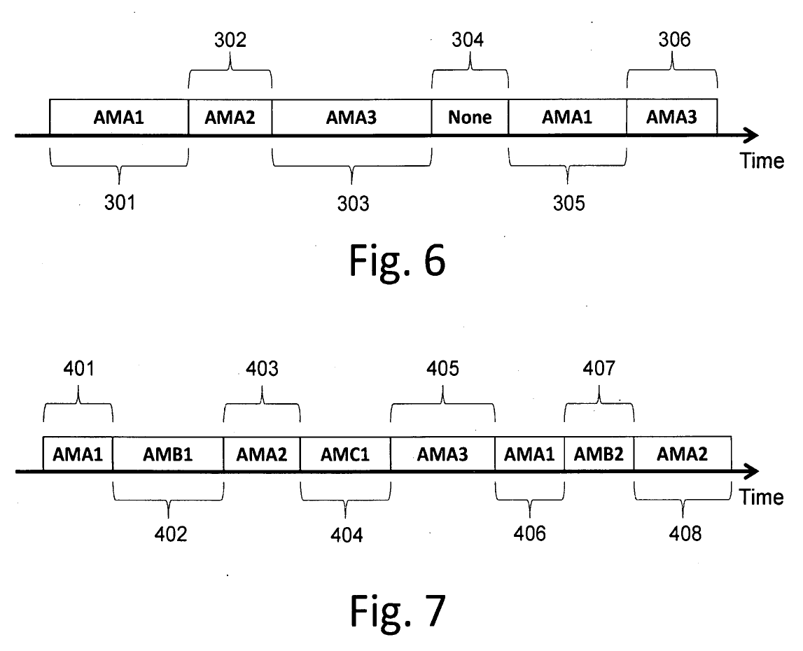

The advertising service or agent may coordinate changing of advertising materials to be distributed by a single retail business over time. The advertising service's changing of advertising materials is to maximize the benefits for the advertisers from distributing the advertising materials and/or to further maximize the benefits for the retail business from providing of the advertising materials to its customers. Exemplary changing of advertising materials, which can be coordinated by the advertising service or agent, is discussed with reference to FIGS. 6 and 7.

FIG. 6 illustrates an exemplary time chart showing changes of advertising materials distributed by a retail business for a single advertiser. In the time window 301, the retail business 103 distributes an advertising material AMA1 of the advertiser 101A. In the following time windows 302 and 303, the retail business 103 distributes advertising materials AMA2 and AMA3 of the advertiser 101A. In the time window 304, the retail business 103 distributes no advertising material. In the time windows 305 and 306, the retail business 103 distributes advertising materials AMA1 and AMA3 again. Here, the advertising materials AMA1, AMA2 and AMA3 include useful items different from each other. Although not illustrated, there may be some overlap of the time windows in which the retail business 103 distributes two or more advertising materials simultaneously.

FIG. 7 illustrates an exemplary time chart showing changes of advertising materials distributed by a retail business for more than one advertiser. In the time windows 401 and 406, the retail business 103 distributes an advertising material AMA1 of the advertiser 101A. In the following time window 402, the retail business 103 distributes an advertising material AMB1 of the advertiser 101B. In the time windows 403 and 408, the retail business 103 distributes an advertising material AMA2, which has a useful item different from that of the advertising material AMA1. In the time window 404, the retail business 103 distributes an advertising material AMC1 of the advertiser 101C. In the time window 405, the retail business 103 distributes an advertising material AMA3, which has a useful item different from those of the advertising material AMA1 and AMA2. Although not illustrated, there may be one or more time windows where the retail business 103 distributes no advertising material of any advertisers. Also, there may be some overlap of the time windows in which the retail business 103 distributes two or more advertising materials simultaneously.

### Affixing Advertisement Onto Automobile

Another aspect of the invention provides a method of affixing an advertisement of an advertiser 101 onto an automobile of a customer of a retail business 103. In this method of affixing advertisement, all or some of acts of the advertiser 101 that are discussed below can be conducted by an advertising service or agent on behalf of the advertiser 101.

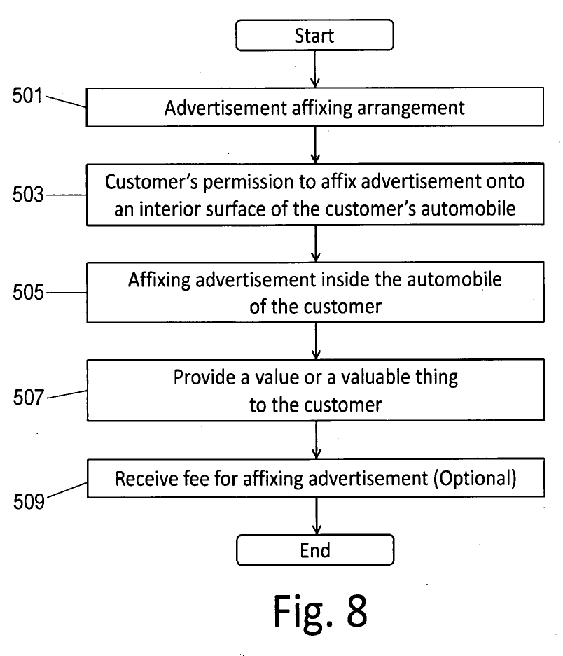

Referring to the flowchart of FIG. 8, an advertiser 101 and a retail business 103 form an arrangement for affixing an advertisement of the advertiser onto automobiles of customers of the retail business 103 (step 501). The retail business 103 provides retail services or retail sales of products to its customers, and the retail business 103 obtains, from a customer 107, permission to affix the advertisement of the advertiser 101 onto an automobile of the customer 107 (step 503). Then, the retail business 103 affixes the advertisement onto a surface of the customer's automobile following the arrangement (step 505). In return for permission to affix the advertisement, the retail business 103 provides a value or valuable thing to the customer 107 (step 507). Subsequently and optionally, the retail business 103 receives a fee for affixing the advertisement from the advertiser 101 (step 507).

### Advertisement Affixing Arrangement

In step 501, the advertiser 101 and retail business 103 form an arrangement for affixing the advertisement 109. In one embodiment, the arrangement defines terms and conditions which the retail business 103 has to follow in affixing the advertisement of the advertiser 101 to receive the fee or compensation for affixing the advertisement. In one embodiment, prior to the arrangement, the advertiser 101 selects a target geographical area in which it wishes to promote its goods and/or services. In one embodiment, the advertiser 101 selects the retail business 103 from two or more retail businesses located in the target geographical area. Although any retail business can be selected for this arrangement, in some embodiments, the retail business 103 is an automobile related business. For example, the retail business 103 is selected from the group consisting of a carwash service, an oil change service, an automobile repair service, installing an automobile part, removing an automobile part, a gas station business, a retail store for automobile parts, a retail store for automobile accessories.

### Obtaining Customer's Permission

In step 503, the retail business 103 obtains the customer's permission to affix an advertisement onto a surface of the customer's automobile. In one embodiment, the retail business 103 inquires its customers if they would be willing to allow affixing of an advertisement onto their automobiles in return for receiving a value or valuable thing. In this regard, the retail business 103 may show one or more sample advertisements to the customers. Also, the retail business 103 may provide the customers with one or more optional locations where the advertisement can be placed.

In embodiments, the retail business 103 obtains the permission from customers of its retail service or sales business in the context of normal operation of the retail business 103. For example, the retail business 103 asks for the permission to its customers who come to its retail business premise to purchase a retail service or product. In embodiments, the retail business 103 inquires for the permission before, after or during the transaction for the retail service or sale with the customer.

### Affixing of Advertisement Onto a Surface of Automobile

In step 505, the retail business 103 affixes an advertisement of the advertiser 101 onto a surface of the automobile of the customer 107 who has permitted the affixing. In one embodiment, the advertisement is affixed onto an exterior or interior surface of the automobile. In embodiments, the advertisement is affixed such that its advertising content is visible and/or readable from the inside of the automobile, regardless of whether the advertising content is affixed onto an exterior or interior surface of the automobile. In one embodiment, the advertisement is affixed onto a surface of the automobile which is viewable or reachable by a driver seating on its driver seat.

In embodiments, the advertisement is affixed onto an exterior or interior surface of the windshield, a door, a window of the automobile. In other embodiments, the advertisement is affixed onto a dashboard, a ceiling, a seat of the automobile. In some embodiments, the advertisement is affixed onto a glass, plastic, leather, metallic, fabric or composite material surface.

In embodiments, affixing includes bonding a preformed piece of advertisement onto a surface of the automobile. In one embodiment, the advertisement is in the form of a sticker, which has an advertising content of the advertiser 101 on one side and an adhesive material on the rear side. In this disclosure, the term “affixing” of the advertisement includes printing of an advertising content onto an inside surface of the automobile. Also, the term “affixing” of the advertisement includes selective etching, charring or burning of a surface to make an advertising content is visible.

### Value Provided to Customer

In step 507, the retail business 103 provides the customer 107 with a value or valuable thing in return for permitting the affixing of the advertisement. In embodiments, the value provided to the customers 107 is selected from the group consisting of a discount for a service rendered by the retail business 103; removal of at least part of an amount charged for a service rendered by the retail business 103; an additional service by the retail business 103 at a discounted rate; an additional service by the retail business 103 for free; cash; a useful item or device that is purchasable in the target geographical area, a gift certificate for use in the retail business 103, the advertiser 101 or a third party business; points or mileage for a frequent customer reward program of the retail business 103, the advertiser 101 or the third party business; a discount coupon for use in the retail business 103, the advertiser 101 or a third party business; a voucher for use in the retail business 103, the advertiser 101 or a third party business; and a combination of two or more of the foregoing.

### Fee for Affixing of Advertisement

In step 507, the retail business 103 receives a fee for affixing the advertisement from the advertiser 101. This step is optional. In some embodiments where the retail business 103 receives a significant benefit of attracting new customers by providing the value in return for affixing the advertisement, and the advertiser 101 may not want to pay for the affixing of its advertisement. In other embodiments, however, the advertiser 101 may need to pay certain fees to the retail business 103 for affixing its advertisement. In some embodiments where the advertiser 101 pays for affixing advertisement, the fee may be fixed for a period or may vary over time. In some embodiments, the fee varies based on at least one selected from the size of the advertisement, the location of affixing, and a content appearing on the advertisement.

In some embodiments, the fee is calculated based on the number or count of affixing of the advertisement onto automobiles of the retail business' customers. In such embodiments, the retail business 101 may need to report the number or count of affixing of the advertisement to the advertiser 101. In some embodiments, reporting of the number or count includes providing evidence of affixing to the advertiser 101. In one embodiment, evidence is one or more selected from the group consisting of a photograph showing at least part of the advertisement affixed onto the vehicle, a photograph of a license plate of the vehicle, a copy of a registration card of the vehicle. In one embodiment, evidence includes a copy of a registration card of the customer's vehicle.

### Use of Coupon or Certificate

In some embodiments, the advertiser 101 provides potential customers of the retail business 103 with a coupon or certificate that can be used in regard to affixing advertisement and providing a value through the retail business. In embodiments, when a customer submits such a coupon to the retail business 103, the submission may constitute permission of the customer for affixing of advertisement onto his/her automobile. In some embodiment, the advertisement 101 requires that the retail business 103 provide the value only to those customers who submit a valid coupon or certificate. In such embodiments, the retail business 103 may collect the coupons from the customers. These collected coupons or a portion of the coupons can be used as evidence for showing the number or count of affixing of the advertisement for calculating the fee for its affixing service. In some embodiments, each coupon or certificate is assigned a unique identification code or number, which can be used for verifying that coupons submitted by the retail business 103 are genuine.

In one embodiment, the advertiser 101 circulates or distributes the coupon in a target geographical area, in which to advertise the goods or services of the advertiser. The advertiser 101 may use a local coupon mailing service, which mails the coupon to homes and businesses in the target geographical area. Also, the advertiser 101 may include the coupon as a flyer in a newspaper or magazine circulated in the target geographical area. Further, the advertiser 101 may include the coupon as an advertisement placed in a newspaper or magazine circulated in the target geographical area.

### Registration for Coupon

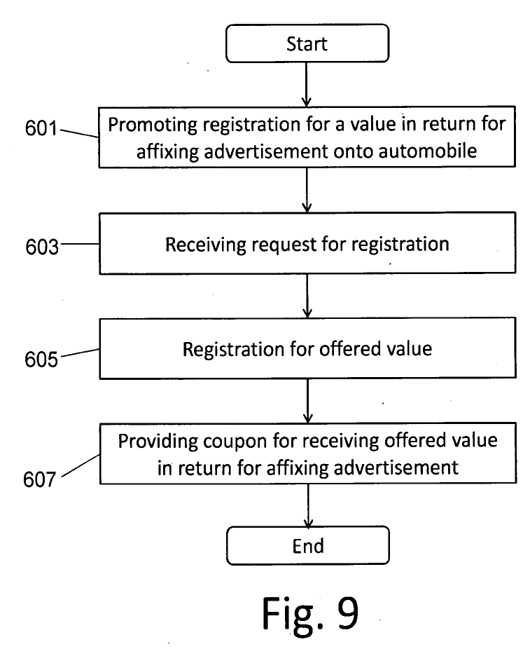

In some embodiments, the advertiser 101 sends a coupon or certificate to those people who have registered for affixing advertisement in return for a value. Referring to FIG. 9, the advertiser 101 promotes the program of registration for receiving a value (step 601). For this, the advertiser 101 may need to announce or publicize the program of registration, affixing advertisement and receiving the value. The advertiser 101 may use the Internet or other forms of advertising for this, such as circulating or distributing such announcement or flyer in the target geographical area. In reply, people request to the advertiser 101 for registration (step 603). This request may be done via a webpage or mail submission. In some embodiments, the request includes one or more of identification of the requester, identification of an automobile of the requester, and the address or e-mail address to which a coupon is to be sent. In one embodiment, one requester may register for more than one automobile.

When the submitted request includes necessary or required information, the advertiser 101 registers the requester or register's automobile(s) for the program (step 605). Subsequently, the advertiser 101 sends a coupon to the requester at the provided address or e-mail address (step 607). Again in embodiments, the coupon is assigned a unique identifier and includes the unique identifier. When the coupon is submitted to the retail business 103, who in turn submits it or its identifier to the advertiser 101 as evidence for calculating the fee for the retail business, the advertiser 101 can confirm that the submitted coupon or its identifier is genuine.

### Advertisement Sticker

In some embodiments, in response to registration for the program, the advertiser 101 sends an advertisement sticker to the registrant or requester for the registration. In one embodiment, each advertisement sticker includes its own unique identifier made of a code or number. In one embodiment, the advertisement sticker is sent instead of the coupon. In another embodiment, the advertisement sticker is sent in addition to the coupon or a certificate to use for receiving a value from a designated retail business, in which the coupon or certificate includes the same unique identifier included on the corresponding advertisement sticker.

In embodiments, the advertisement sticker is sent along with instructions, which the registrant needs to follow to receive the offered value. In one embodiment, the instruction is to require that the registrant affix the advertisement sticker on his/her automobile and show the affixed advertisement sticker to a designated retail business for receiving the offered value. Upon such showing, the designated retail business 103 confirms proper affixing of the advertisement sticker onto the registrant's automobile as instructed and provides a value to the registrant, who is a customer of the retail business 103, in accordance with its arrangement with the advertiser 101. In one embodiment, the retail business 103 may receive the coupon or certificate that the advertiser 101 sent to the registrant and that includes a unique identifier, and submit the coupon/certificate or its portion to the advertiser 101 for receiving a fee for its service.

In another embodiment, the instruction is to require that the registrant takes the advertisement sticker to a designated retail business without affixing. Then, the designated retail business 103 affixes the advertising sticker onto an automobile of the registrant, who is a customer of its retail business, and provides a value to the registrant in accordance with its arrangement with the advertiser 101. In one embodiment, the retail business 103 may receive the coupon or certificate that the advertiser 101 sent to the registrant and that includes a unique identifier, and submit the coupon/certificate or its portion to the advertiser 101 for receiving a fee for its service.

### Advertiser as Automobile Incidence Service

As discussed above, the advertiser 101 can be any business. In one embodiment, the advertiser 101 is in a business running a vehicle or automobile incidence assistance service. In this embodiment, the advertisement of the advertiser 101 includes a telephone number, and the advertiser 101 receives a telephone call from a driver or passenger of the automobile at the telephone number for consultation regarding an incidence involving the automobile or driver of the automobile. In reply, the advertiser 101 renders an advice as to how to handle the incidence to the driver or passenger over the phone.

Here, a vehicle incidence refers to a traffic accident, a stop by a law enforcement officer for a potential traffic violation, a stop by a law enforcement officer for a testing for driving under intoxication, or any emergency situation that can occur during driving. In embodiments, the advice includes a legal advice, making or keeping a record of the incidence, reporting the incident to a law enforcement agency, reporting the incident to an insurance company, cleaning a site of the incidence, and treating a person involving the incidence. In these embodiments, the advertiser 101 also refers the driver or passenger to a third party service that can be of further assistance to the driver or passenger regarding the incidence. The advertiser 101 in these embodiments receives a subscription fee from the third party service.

What is claimed is:

1. A method of advertising, comprising:
selecting a first carwash business among many carwash businesses located in a target geographical area for advertising a professional service business unrelated to the first carwash business;
providing the first carwash business with an advertising material of the professional service business, wherein the advertising material comprises a useful device and further comprises advertising information of the professional service business; and
causing the first carwash business to distribute the advertising material to customers of the first carwash business.

2. The method of claim 1, wherein the advertising material is provided to the customers, who have purchased a carwash service from the first carwash business.

3. The method of claim 1, wherein causing the first carwash business to distribute comprises causing the first carwash business to install or place the advertising material inside an automobile of a customer who has purchased a carwash service.

4. The method of claim 1, wherein the advertising material further comprises advertising information of the first carwash business.

5. The method of claim 1, further comprising:
selecting a second carwash business among the many carwash businesses located in the target geographical area;
providing the second carwash business with the advertising material of the professional service business; and
causing the second carwash business to distribute the advertising material to customers of the second carwash business.

6. The method of claim 5, wherein the first and second carwash businesses are caused to distribute the advertising material substantially simultaneously.

7. The method of claim 5, wherein the first carwash businesses is caused to start distributing the advertising material first, and then the second carwash business is caused to start distributing the advertising material after a predetermined period from the first carwash business' starting or completing of distributing the advertising material.

8. The method of claim 5, wherein the first carwash business has a first carwash service premise located in the target geographical area, and the second carwash business has a second carwash service premise located in the target geographical area, wherein the first and second carwash service premises are distanced from each other more than a predetermined distance.

9. The method of claim 5, wherein the first carwash business has a first carwash service premise located in a first predetermined zone, wherein the second carwash business is selected as having a second carwash service premise located in a second predetermined zone differing from the first predetermined zone.

10. The method of claim 9, wherein the first and second predetermined zones are of two nearby zip codes.

11. The method of claim 1, wherein the target geographical area is defined as at least one selected from the group consisting of a city, a county, a metropolitan area, a zip code, a cluster of cities, a cluster of counties, and a cluster of zip codes.

12. The method of claim 1, wherein no net payment is made by the professional service business or its agent to the first carwash business for distributing the advertising material.

13. The method of claim 1, wherein providing the advertising material comprises selling the advertising material to the first carwash business at a price about or lower than either or both of the F.O.B. destination cost of the advertising material to the first carwash business and a wholesale price of the useful device in the target geographical area.

14. The method of claim 1, wherein selecting, providing and causing are performed by the professional service business or an advertising service.

15. The method of claim 14, further comprising:
providing the first carwash business with another advertising material of another professional service business, the other advertising material comprising the useful device or another useful device, the other advertising material further comprising advertising information of the other professional service business; and
causing the first carwash business to distribute the other advertising material to customers of the first carwash business.

16. The method of claim 14, wherein selecting, providing and causing are performed by the advertising service, wherein the method further comprises:
receiving, by the advertising service, a fee for distributing the advertising material in the target geographical area.

17. The method of claim 16, wherein the fee is determined based on at least one selected from the group consisting of an F.O.B. destination cost of the advertising material to the first carwash business, a market price of the useful device in the target geographical area, and a market price of an equivalent device in the target geographical area.

18. The method of claim 16, wherein the fee is about or lower than a market price of the useful device or an equivalent device in the target geographical area.

19. The method of claim 1, wherein the professional service business is at least one selected from the group consisting of a law firm, a lawyer, an accounting firm, an accountant, a real estate broker, a real estate brokerage firm, a recruiting firm, a recruiting agent, a translator, an engineering firm, a hospital, a clinic, a physician, a business consulting firm, and a business consultant.

20. A method of placing an automobile accessory in an automobile in a target geographical area while the automobile is located at a carwash business in the target geographical area, the method comprising:
making a first arrangement with a professional service business for advertising the professional service business in a target geographical area;
selecting a carwash business located in the target geographical area;
making a second arrangement with the selected carwash business for distributing an advertising material of the professional service business;
providing the carwash business with the advertising material of the professional service business, the advertising material comprising an automobile accessory and further comprising advertising information of the professional service business; and
causing the carwash business to place the advertising material in automobiles of customers, who have purchased a carwash service from the carwash business.
